(19) United States
(12) Patent Application Publication
(10) Pub. No.: US 2025/0111664 A1
(43) Pub. Date: Apr. 3, 2025

(54) SYSTEMS AND METHODS FOR UTILIZING MEDIA ITEMS ASSOCIATED WITH A PROFILE TO ALTER A CONTENT ITEM

(71) Applicant: Adeia Guides Inc., San jose, CA (US)

(72) Inventors: Jean-Yves Couleaud, Mission Viejo, CA (US); Milena Sukovic, Naples, FL (US)

(21) Appl. No.: 18/374,322

(22) Filed: Sep. 28, 2023

(51) Int. Cl. G06V 10/94; G06F 3/04845; G06F 3/0487; G06T 11/60; G06V 10/70; G06V 10/86; G06V 20/30; G06V 20/70

(52) U.S. Cl. CPC G06V 10/945; G06F 3/04845; G06T 11/60; G06V 10/70; G06V 10/86; G06V 20/30; G06V 20/70; G06F 3/0487; G06T 2200/24; G06V 2201/10

(57) ABSTRACT

Systems and methods are provided for altering a content item via a trained machine learning model. One or more media items associated with a user profile are accessed at a computing device, and for each media item, one or more labels associated with an element in the media item are retrieved. A content item is accessed, and a structured description of one or more elements in the content item is received. A structured request to alter one or more elements in the content item is generated based on the description. The one or more elements to alter are identified in the content item and based on the request. The one or more elements in the content item are altered using a trained machine learning model and based on the one or more labels. An altered content item comprising the one or more altered content item elements is generated for output.

### FIELD OF THE DISCLOSURE

One or more disclosed embodiments are directed towards systems and methods for utilizing media items associated with a profile to alter a content item with a trained machine learning model in response to a structured request.

### BACKGROUND

With the availability of deep learning and text-to-image models, the artificial intelligence-aided generation and editing of images, videos and audio items is becoming increasingly popular. However, successful generation and/or editing of images tends to be an iterative process with additional prompts, both positive and negative, being utilized in response to a generated or edited item, in order to generate or edit an image, video or audio item as desired. Furthermore, finding and utilizing reliable prompts can involve a large amount of guesswork on the behalf of a user. The iterative nature of the generation and editing of images, video and audio items gives rise to wasted computing resources such as processing cycles to edit and/or generate the items and network bandwidth to transfer the items. In addition, there may be scenarios where a user wishes to generate an edited image, video or audio item in a just-in-time manner. In such a scenario, it is not practical, or feasible, to go through an iterative process to find an item that is generated in a desired manner. One way of editing content items with artificial intelligence is via deep learning and general adversarial networks, which may be utilized to replace and/or manipulate, for example, the faces of people in a content item. This may involve, for example, swapping faces entirely and/or manipulating facial expressions. In some examples, speech in a content item may also be manipulated in a similar manner. However, such an approach with deep learning and general adversarial networks tends to be resource intensive, both in terms of the resources required to gather the data required to be able to cast a replacement face (or character) on an original face (or character). In particular, due to the resource requirements, it is not practical to use existing deep learning and general adversarial networks to generate customized content items in real-time for insertion into a streamed content item. In order to reduce the wasted resources associated with the iterative nature of artificial intelligence-aided generation and editing of images, videos and audio items and to speed up the process to enable advanced features such as just-in-time editing, there is a need to provide an improved way of generating and editing images, videos and audio items when utilizing artificial intelligence.

To help address these problems, systems and methods are provided for utilizing media items associated with a profile to alter a content item with a trained machine learning model in response to a structured request.

### SUMMARY

In accordance with some aspects of the disclosure, a method is provided. The method includes accessing, at a computing device, one or more media items associated with a user profile, and retrieving, for each media item, one or more labels associated with an element in the media item. A content item is accessed, and a structured description of one or more elements in the content item is received. A structured request to alter one or more elements in the content item is generated based on the structured description, and the one or more elements to alter are identified in the content item and based on the structured request. The one or more elements in the content item are altered using a trained machine learning model and based on the one or more labels, the one or more media items, and the structured request. An altered content item comprising the one or more altered content item elements is generated for output.

In an example system, a content item editing system accesses one or more media items (e.g., image(s)) associated with a user profile of a social media account or other profile account, such as images that a user has stored with the profile or posted to the social media account. In another example, a content editing system may access one or more images associated with an over-the-top media account, such as images of Pierce Brosnan associated with a Paramount+ account. In this example, the user has posted a plurality of images of themselves to their social media account, and a plurality of images of cups of coffee. For each accessed image, a label associated with an element (e.g., a person, object, animal, etc.) in the image is retrieved, for example, via metadata associated with the accessed images. For example, an image of the user may have the label “user” associated with it, and an image of a cup of coffee may have the labels “cup” and “coffee” associated with it. In this example, the system receives or accesses a content item, and receives or accesses a structured description of elements in the content item. For example, the description may comprise “[a man] drinking a [beverage],” in which the elements “a man” and “beverage” are identified in brackets. The system generates a structured request to alter one or more of the elements, for example, “[the User] drinking a [coffee].” The system may then alter the content item, via a trained machine learning model and based on labels and associated accessed images, to comprise the User drinking a coffee, rather than a generic or unrelated person drinking a beverage.

### BRIEF DESCRIPTIONS OF THE DRAWINGS

The present disclosure, in accordance with one or more various embodiments, is described in detail with reference to the following figures. The drawings are provided for purposes of illustration only and merely depict example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows an example environment for utilizing media items associated with a profile to alter a content item with a trained machine learning model in response to a structured request, in accordance with some embodiments of the disclosure;

FIG. 2 shows an example altered content item, in accordance with some embodiments of the disclosure;

FIG. 3 shows an example environment for selecting one or more settings to apply to a content item element, in accordance with some embodiments of the disclosure;

FIG. 4 shows an example environment for altering a content item and delivering the altered content item, in accordance with some embodiments of the disclosure;

FIG. 5 shows an example environment for altering a content item and delivering the altered content item, in accordance with some embodiments of the disclosure;

FIG. 6 shows a flowchart of illustrative steps involved in utilizing media items associated with a profile to alter a content item with a trained machine learning model in response to a structured request, in accordance with some embodiments of the disclosure;

FIG. 7 shows an example environment for utilizing media items associated with a profile to alter a content item with a trained machine learning model in response to a structured request, in accordance with some embodiments of the disclosure;

FIG. 8 shows another example environment for utilizing media items associated with a profile to alter a content item with a trained machine learning model in response to a structured request, in accordance with some embodiments of the disclosure;

FIG. 9 shows a flowchart of illustrative steps involved in utilizing media items associated with a profile to alter a content item with a trained machine learning model in response to a structured request, in accordance with some embodiments of the disclosure;

FIG. 10 shows a block diagram representing components of a computing device and dataflow therebetween for utilizing media items associated with a profile to alter a content item with a trained machine learning model in response to a structured request, in accordance with some embodiments of the disclosure; and

FIG. 11 shows a flowchart of illustrative steps involved in utilizing media items associated with a profile to alter a content item with a trained machine learning model in response to a structured request, in accordance with some embodiments of the disclosure.

### DETAILED DESCRIPTION

A media item is any media comprising one or more elements that can be associated with a user profile and includes images, a portion of an image or video or audio or text, videos, audio clips, text and/or animations. A media item may be a photo of a pet, an audio clip of a friend, any recorded aspect of a person/place/thing, such as an actor or other individual noted in the user profile as a favorite, and/or a description of a location.

A content item includes an image, a picture, audio, video, text, a video game and/or any other media content. A content item may be a single media item. In other examples, it may be a series (or season) of episodes of content items. Video includes audiovisual content such as movies and/or television programs or portions thereof. Audio includes audio-only content, such as podcasts or portions thereof. Text includes text-only content, such as event descriptions or portions thereof. One example of a media content item is one that complies with the MPEG DASH standard. An over-the-top, streaming and/or video-on-demand service (or platform) may be accessed via a website and/or an app running on a computing device, and the device may receive any type of content item, including live content items and/or on-demand content items. Content items may, for example, be streamed to physical computing devices. In another example, content items may, for example, be streamed to virtual computing devices in, for example, an augmented environment, a virtual environment and/or the metaverse. For example, a content item may comprise an advertisement, or a video celebrating the friendship between two users using their respective likeness.

An element is any identifiable thing, portion, surface, or area (or combination thereof) within a media item or a content item. Elements include objects, such as cars, buildings, people, pets, billboards, signs, lettering, text, surfaces (such as a side of a building, a sidewalk, grass, etc.), items (such as smartphones, gaming consoles, and/or watches), and the like. An element may be present in the foreground and/or the background of a media item and/or content item. Altering a content item comprises identifying an element in the content item and altering it to present an element of the same type (e.g., a pet) and/or a different element entirely (e.g., replacing a pet with a car). Altering the content item may comprise altering an element in the foreground and/or the background of the content item.

A structured description includes indicators of segments that are defining the elements that can be altered based on the trained machine learning model. In some examples, the structured description may comprise a template with specific elements that may be altered. For example, the template may comprise an indicator, such as square brackets, that indicate the elements that may be altered. In other examples, the structured description may be a natural language description, but structured in a specific format, for example, a first paragraph that corresponds to a first scene in a content item, a second paragraph that corresponds to a second scene in a content item and so forth. In a further example, a structed description may be structured with respect to a specific file format, for example, an extensible markup language (XML) file format.

The disclosed methods and systems may be implemented on one or more devices, such as user devices and/or computing devices. As referred to herein, the device can be any device comprising a processor and memory, for example, a handheld computer, a mobile telephone, a portable video player, a portable music player, a portable gaming machine, a smartphone, a smartwatch, a smart speaker, an augmented reality headset, a mixed reality device, a virtual reality device, a gaming console, or any other computing equipment, wireless device, and/or combination of the same.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, floppy disk, USB drive, DVD, CD, media cards, register memory, processor caches, random access memory (RAM), a solid state drive, a NVMe drive and/or quantum memory, etc.

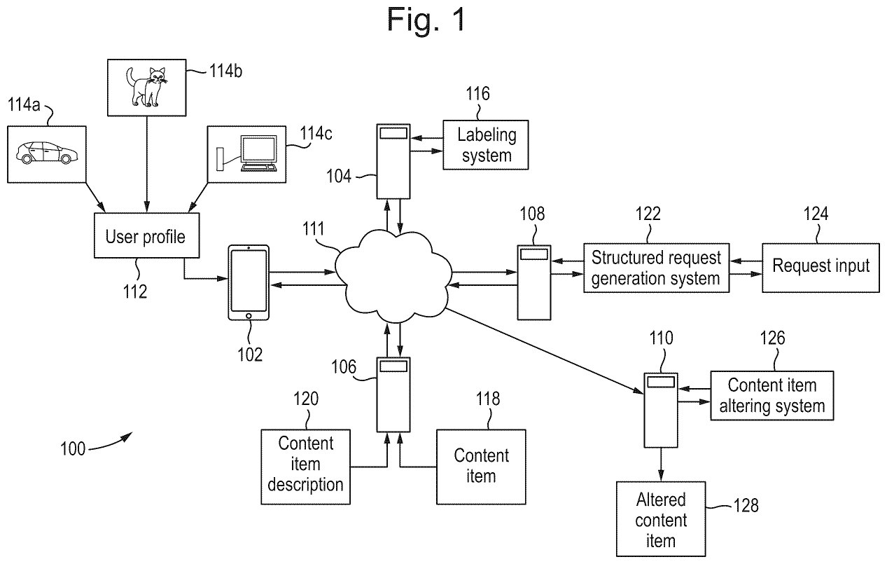

FIG. 1 shows an example environment for utilizing media items associated with a profile to alter a content item with a trained machine learning model in response to a structured request, in accordance with some embodiments of the disclosure. The environment 100 comprises a first computing device 102, such as a user device, and second, third, fourth, and fifth computing devices 104, 106, 108, 110, such as servers, connected via a network 111, such as the internet. Although a plurality of servers are depicted in FIG. 1, any number of servers may be utilized. In some examples, a single physical, or virtual, server may be used. In other examples two, three or four physical, virtual and/or a mix of physical and virtual servers may be used to implement the environment depicted in FIG. 1.

At the first user device 102, a user profile 112 is accessed along with a plurality of media items 114a-114c associated with the user profile 112. In this example, the media items comprise a first image 114a of a car, a second image 114b of a cat, and a third image 114c of a gaming console connected to a television. In this example, the car is an element in the first image 114a, the cat is an element in the second image 114b, and the gaming console is a first element in the third image 114c, and the television is a second element in the third image 114c. Although three media items are shown in this example, any number of media items is covered by a respective embodiment. In some examples, all media items associated with a user profile may be selected. In other examples, only a subset of media items associated with the user profile may be selected. This subset may be selected based on any criteria. This may include, for example, only those media items within a certain age or date range, for example, those media items generated in the last month. In some examples, the subset may be selected based on, for example, an identified location associated with a computing device. In other examples, input may be provided via a user interface for selecting for inclusion in personalized media a subset of the media items. The media items may be any media items including, for example, images, videos, audio clips, text and/or animations, or portions thereof.

The media items may be a set of media items identified via, for example, a user profile or a social media platform as being posted by a particular user profile 112, or by a set of user profiles in the same social circle as the particular user profile 112, thereby representing elements that a user associated with the user profile may be familiar with. These media items may represent the user themselves, other users that are part of the user's social circle, the user's family members and/or pets and/or objects. The media item can be a person, place, or thing specified as a favorite or other tag associated with the user profile. For example, a user may have a profile or account with a media or gaming provider, wherein the user specifies a favorite, followed, or liked person, place, or thing, such as an avatar, cartoon character, background item, any aspect of an item designated as a favorite via selection or via a detection of frequent use, selection, or interaction. Any aspect of the favorite person, place, or thing can be used as a media item with associated one or more elements. The media items may also represent elements that the user uses frequently such as their car, bicycle, video game console and/or smartphone. These elements may also be art for movies, series, sport events, and/or music the user may have posted about in the past.

The media items 114a-114c may be labelled by the user or a person familiar with the user or may be transmitted, via network 111, to a labeling system 116. In other examples, the labeling system 116 may access the media items via, for example, an application programming interface (API) associated with a social network of the user profile 112. In this example, the labeling system 116 runs on a second server 104 and generates labels for one or more elements in the media items. In other examples, the labeling system 116 may run on any other of the servers described in connection with FIG. 1. The labeling may be performed via, for example, a trained machine learning model. In other examples, the labels may be generated via, for example, a system associated with a social network that the media items have been uploaded to and/or an application associated with the media items. In a further example, the labels may be inferred from metadata associated with the media items. In a further example, the profile or account holder can specify the label or tag to be associated with a media item.

In this example, a content item 118 is accessed at the third server 106, along with a content item description 120. In other examples, the content item may be accessed at any other of the servers described in connection with FIG. 1. A content item may be any content item comprising one or more elements that are alterable or replaceable. For example, a content item may be a video, an image and/or an audio-only content item. The content item description 120 may be a structured content item description, stored in a data structure. The content item description 120 may have a format that enables it to be parsed by a computing device and/or ingested by a trained machine learning model, such that the trained machine learning model can interpret the contents of the content item. In some examples, the content item description 120 may comprise fields that indicate elements that may be altered in the content item. For example, the content item description 120 may comprise one or more labels that indicate which elements may be altered. In further examples, a plurality of content item descriptions 120 may be generated for a content item if, for example, the content item is a video comprising a plurality of scenes.

In this example, the content item description 120 is transmitted, via network 111, to server 108, where a structured request generation system 122 generates a structured request for altering the content item 118. In other examples, the structured request generation system 122 may run on any other of the servers described in connection with FIG. 1. For example, a user interface may be generated comprising the structured description and an indication of which elements can be altered. For example, the description of the content item may read “[a cat] is sitting under [a tree].” In this example, the square brackets indicate which elements may be altered. In some examples, the labels generated by the labeling system 116 may be transmitted to the structured request generation system 122, and only those elements for which a media item 114a-114c exists may be indicated as being alterable. Input 124 may be provided via the user interface to change the request to “[user's cat] is sitting under user's tree].” In some examples, the structured request may enable freeform input such as, via a keyboard. In other examples, the structured request may enable a limited input such as, via a dropdown menu that is populated on the labels generated by the labeling system 116. In some examples, the structured request may comprise additional modifiers associated with the elements, such as [enlarge], [shrink], [put partially behind tree or other location modifier with respect to another image element tree]. In this way, the elements may not be a direct one-for-one replacement, and modification of the background of the content item may be automatically altered to accommodate the additional modifiers. In some examples, a relationship may be defined between two elements, such as “[man] [hold] [coffee].” In other examples, a relationship between two people in the content item may be changed, for example “[a man] [hugs] [his son]” may be replaced with “[the user] [holds hands with] [a friend].” In examples where the content item is a video, further actions between the two people may be automatically altered based on the revised relationship between the two people. In some examples, the structured request may comprise positive and/or negative prompts. A positive prompt may be a request to do something to an element in the content item, whereas a negative prompt may be a request to not do something to an element in the content item. For example, a positive prompt may comprise replacing a cat with a dog, whereas a negative prompt may be “brown,” indicating that the dog should have any color hair or fur other than brown such as, black hair or fur. In a further example, the structured request generation system 122 may integrate an artificial intelligence chatbot that enables a user to provide natural language input, and that may optionally provide feedback based on the received labels in order to guide a user to altering elements for which a media item exists. If a plurality of content item descriptions 120 are received, then a corresponding plurality of structured requests may be generated by the structured request generation system 122.

The content item 118 and the structured request are transmitted, via network 111, to the fifth server 110, where a content item altering system 126 alters the content item based on the one or more labels generated via the labeling system 116, the one or more associated media items accessed via the user profile 112 and the structured request generated by the structured request generation system 122. In other examples, the content item altering system 126 may run on any other of the servers described in connection with FIG. 1. The fifth server takes the structured request, for example, “[my cat] is sitting under [my table]” and alters the associated elements in the content item as directed by the structured request. For example, a generic cat in the content item may be replaced by a cat that has been identified in a media item 114b associated with the user profile 112, and the table may be replaced by a user's table (not shown) that has been identified in a media item associated with the user profile 112. The content item altering system 126 may access a plurality of media content items with the same label in order to improve the quality of any alteration made to the content item. Feedback may also be provided, requesting, for example, additional media items of a particular element if they are available. After altering the content item 128, it may be provided for output. Enabling the alteration of elements within a content item via a structured description, rather than conventionally altering the whole content item, enables the system to generate altered content items in a faster, on-demand manner, and to reduce the processing resources associated with altering a content item, when compared to a system that conventionally alters the whole content item. This may be particularly beneficial, for example, when inserting an altered content item into a streamed content item substantially in real-time.

Each of the labelling system 116, structured request generation system 122 and the content item altering system 126 may be a hardware defined system, a software defined system and/or a combination of a hardware and software defined system. A combination of hardware and software systems may be utilized.

In one example, a streaming service may prompt a user as to whether they would like content items, such as, advertisements or movies or songs or other content, to be customized with their permitted character traits, before streaming a streamed content item to a device associated with the user. After the user has indicated that they would like a content item that is transmitted to the device associated with the user to be customized, a content item edit module (located at the streaming service in association with the user profile) may take the permitted character data for use in generation of a new character model. The new character model may then be used to replace the original characters in a content item such as, advertisements. The new character model may be auto-generated from data made available or permitted by the user, for example by the user selects which of their stored character data may be allowed for use by the streaming service profile. The streaming service may use the permitted character data, which can be described as an element of a media item stored in association with the user profile, to auto-generate a model character that represents a single permitted character for use in content item editing, such as, advertisement or movie or song or other media editing.

An advertising system of a social media platform may use the media items 114a-114c to train a plurality of generative artificial intelligence image models to generate personalized images or videos of the items represented in the set of images posted by the user profile 112. When receiving a request to serve an advertisement (i.e., a type of content item) to that user profile 112, the social media platform's advertising system may also receive a generic video, image and/or a script and use it in conjunction with the trained models to generate a personalized video or image depicting one or more of the items depicted in the video per the received script, as described in connection with FIG. 1 above.

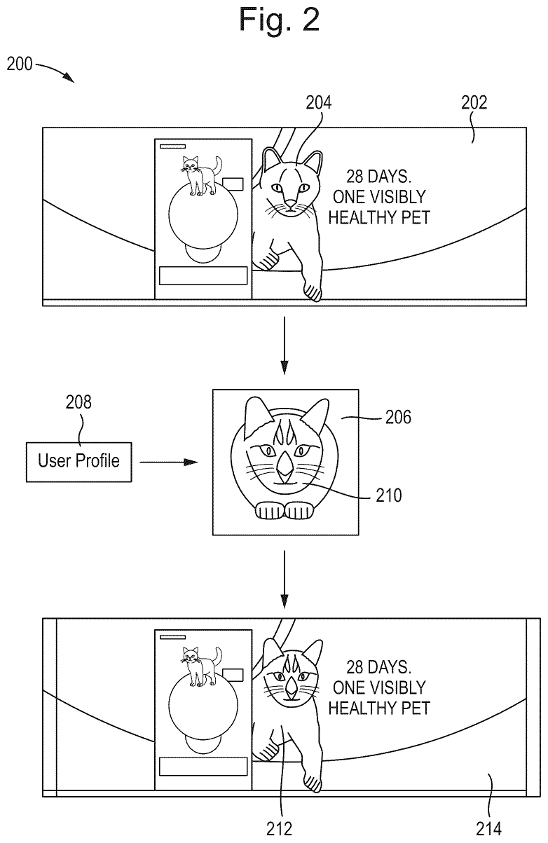

FIG. 2 shows an example altered content item, in accordance with some embodiments of the disclosure. The environment 200 comprises a content item 202, in this example, an advertisement. The content item 202 comprises a first content item element 204, in this example, a first cat. A media item 206 is accessed via a user profile 208. The media item comprises a media item element 210, in this example, a second cat. The content item is altered to replace the first content item element 204 with a second content item element 212, which is based on the media item element 210 to produce an altered content item 214. The altered content item 214 may be produced via any of the examples, method and/or systems discussed herein.

In an example, a pet food company may wish to advertise a new line of products to pet owners. The pet food company may decide to create a generic content item, such as, advertisement banner 202 targeted for cat owners. A content item editing system, such as, an advertisement system, of a social platform may receive the banner 202 as well as a set of media items 114b (only one of which is shown, i.e. a cat associated with the user's profile) from a user profile 112. The content item editing system of the social platform may train a text-to-image model to generate images of the user's cat based on the image 114b of the user's cat collected through their social media profile and/or posts. Using this trained model, the content item editing system of the social platform may then edit the user's cat into the generic advertisement banner 202 targeted for the cat owner.

The content item editing system may receive a structured description of the content item (such as a video or image), such as, advertisement 202, to show to a user, and the content item editing system may generate that content item using the text-to-image models trained on the media items 114a-114c associated with the user profile 112. The media items may comprise objects, people and/or pets familiar to the targeted user that are to be featured in the personalized advertisement (i.e., type of content item). In an example, the advertising system may receive a structured description of the content item as follows: “a young [boy], a middle aged [woman] and an elderly [lady] give their [dog] some [dog] food with a packet of brand [dog] food overlaid on the right side of the image.” In this example, the structured description describes the content item (such as an image, or a segment in a video) as a reference to create a personalized content item (such as an image, or segment of video) for a targeted user, for example, for advertising purposes. The square brackets in this example indicate the elements for altering to be replaced with elements familiar to the targeted user of the user's family. The content item editing system may determine that this particular user is not a dog owner but a cat owner, and may replace the dog with the user's cat using a text-to-image model trained on a plurality of media items 114b of the targeted user's cat collected from the user's interactions on the social platform. Additionally, the content item editing system may also replace the [boy] with the targeted user's nephew using a text-to-image model trained on a collection of media items (not shown) of the targeted user's nephew that the targeted user may have shared on their social media feed. The content item editing system may also replace the lady with the user themselves and the woman with the user's daughter. The resulting content item, such as an image or video, may represent the targeted user feeding her cat the brand cat food with her nephew and daughter.

In a further example, the content item editing system may compensate a user or actor or other right holder whose data is selected to replace a media item in the content, for example an actor (not necessarily a professional actor, but actor in the sense that their data is being used in the altered content) whose name, image, or likeness is used to generate content items, such as, advertisements, for other users to view. Compensation may include monetary funds, credits to a subscription system, reduced advertisement loads for a certain duration and/or other advantages that could be granted for using the platform on which the content items are generated and shown. In a further example, a content item editing system can compensate an individual whose name, image, or likeness or other right was chosen by the user to generate an altered content item.

In another example, a targeted user may be informed that the likeness of a person, pet, or object they are familiar with was used to show them a content item, such as, an advertisement. In other examples, the same information may be available in the platform used to generate or show content item terms and conditions, or a privacy policy. In some examples, a targeted user may provide feedback about the content item that they were just shown or general feedback about a personalized content item, such as, advertisements. In some further examples, a user may provide feedback to the platform that they do not want to see a particular element, such as a person, object, or pet in a personalized content item.

In some embodiments the image models, such as text-to-image or generative artificial intelligence models, may be trained to achieve a certain threshold level, or percentage, of likeness to an element, such as an object, person and/or pet the targeted user is familiar with. For example, the content item may show a version of the targeted user's familiar pet as “cartoonized” instead of a photorealistic rendering of that same pet.

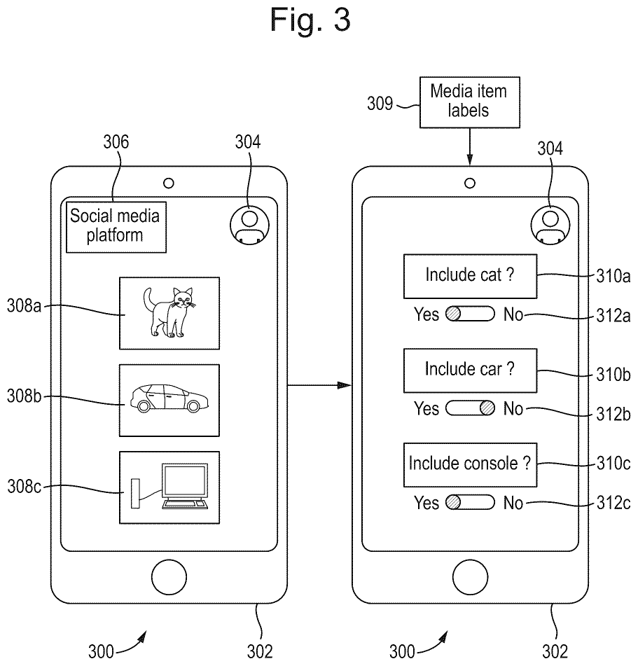

FIG. 3 shows an example environment for selecting one or more settings to apply to a content item element, in accordance with some embodiments of the disclosure. A setting may, for example, cause (or prevent) a labelled media item, and/or a category of labelled media items, to be used as the basis for altering a content item. The environment 300 comprises a computing device 302, such as a smartphone. At the computing device 302, a user profile 304 is accessed via a social media platform 306, and a plurality of media items 308a, 308b, 308c associated with the user profile 304 and/or the social media platform are accessed. In this example, the media items 308a-308c are respective images of a cat, a car and a gaming console. Media item labels 309 are accessed and are transmitted to the computing device 302. For example, the media item labels may be generated by a media item element recognition system where a trained machine learning model identifies one or more elements in the media items. The trained machine learning model may be, for example, implemented at the computing device 302. In some examples, an artificial intelligence accelerator, such as a Samsung Exynos and/or a Google Tensor processor may be utilized at the computing device 302 to label the element, or elements, in the media items 308a-308c. In another example, a server (not shown) remote from the computing device 302 may be utilized, and the computing device may communicate with the server via a network such as the internet. The server may comprise a server-grade artificial intelligence accelerator. In some examples, the media items 308a-308c may be accessed via an API associated with the social media platform 306. In other examples, the media items 308a-308c may be directly transmitted to the computing device 302 and/or server. In a further example, metadata and/or labels may be generated by the social media platform, and these labels may be retrieved by the computing device, optionally via an API.

At the computing device, a plurality of labels 310a-310c are generated for output and are displayed at the computing device 302. Toggles 312a-312c associated with each of the elements and/or media items are generated for output and are displayed at the computing device 302. The toggles enable a user to change settings associated with each media item and/or identified element in a media item. For example, the toggles may enable a user to include and/or exclude a media item. In another example, any identified element such as a cat, a car and/or a gaming console may be included and/or excluded via a toggle. In some examples, a media item may comprise a plurality of identified elements. In these examples, the whole media item may be either selected or deselected. In another example, only some of the elements that were identified may be selected or deselected. In some examples, one or more filters may be applied to the toggles, such as a filter that causes a toggle to be generated for elements that a user is familiar with. Such a familiarity may be identified via a user profile. In another example, a filter may be applied in response to identifying that a number of labels is over a threshold amount. For example, a user may post a single picture of their car and ten pictures of their grandpa, and the toggle will only be generated for the user's grandpa, as it is inferred that a familiarity exists due to the number of pictures posted. Once the user posts additional pictures of their car (e.g., over a threshold amount or number), a new toggle may be generated for the car, and, optionally, a notification may also be generated.

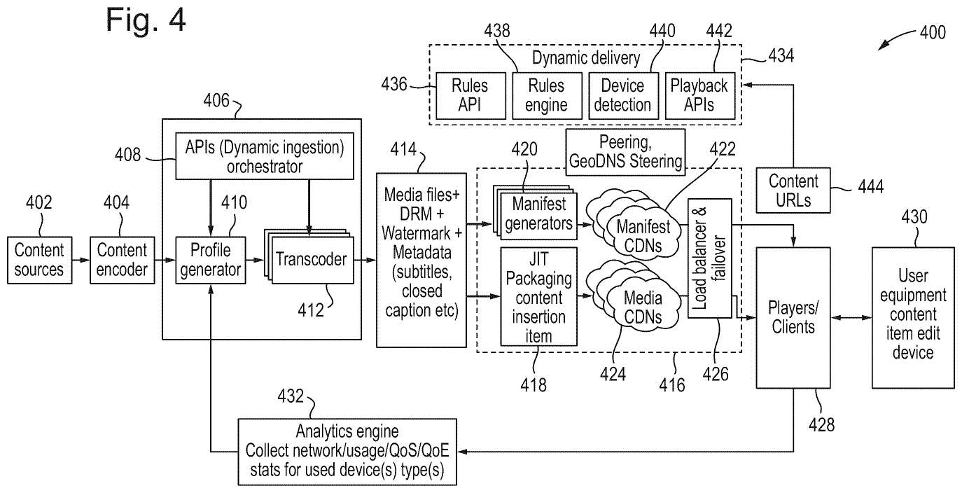

FIG. 4 shows an example environment for altering a content item and delivering the altered content item, in accordance with some embodiments of the disclosure. The environment 400 comprises a content delivery system including one or more user equipment editing technology devices and modules. The system comprises one or more content sources 402, a content encoder 404, learning module 406, a streaming module 414, a peering module 416, an output module, a UCED device 430 and a dynamic delivery module 434.

The one or more content sources 402 each provide one or more content items to the content encoder 404. The content encoder provides an encoded content item to the learning module 406. The learning module 406 may enable personalization of the content item, discovery of the content item, the content item to be searched, and/or identify a genre, title and/or group of the content item. The learning module 406 comprises an API orchestrator 408, a profile generator 410 and a transcoder 412. The profile generator 410 receives encoded content from the content encoder 404 and input from the API orchestrator 408. The profile generator 410 provides output to a transcoder 412, which also receives input from the API orchestrator 406. The transcoder 412 provides a transcoded content item and transmits it to the streaming module 414. The streaming module 414 comprises one or more dynamic adaptive streaming over HTTP (DASH), HTTP live streaming (HLS), hierarchical data format (HDF), common media application format (CMAF) and/or Smooth Streaming modules. The streaming module may fragment the transcoded media item into one or more segments, apply digital rights management (DRM), watermark and/or receive metadata associated with the content item, such as subtitles and/or closed caption data. The content from streaming module 414 is transmitted to a peering and GeoDNS steering module 416. The content goes through a just-in-time packaging and content item insertion module 418. The content item may comprise an advertisement. The content item may be altered with a trained machine learning model in response to a structured request at the content item insertion module 418, as described herein. The content is then transmitted to one or more media content delivery networks (CDNs) 424. The content is also transmitted from the streaming module 414 to one or more manifest generators 420, where one or more manifests for the content are generated. The manifests are then transmitted to one or more manifest CDNs 422. The manifest and content are transmitted via a load balancer and failover 426 via a network, such as the internet, to one or more media players and/or clients 428.

The one or more media players and/or clients 428 communicate with a user equipment content item editing device 430, which is configured to edit the content item that was inserted at the just-in-time packaging and content item insertion module 418 in any manner described herein. Just-in-time includes delivering the altered user requested content to not appear slower than if an unaltered version of the content were delivered, or in a way that keeps delivering other content while the altered content is being processed for packaging and insertion. An analytics engine 432 collects network, usage, quality of service (QOS) and/or quality of experience (QoE) statistics for the used one or more devices and/or one or more types of used device. The data collected by the analytics engine 432 is transmitted to the profile generator 410.

At 444, content URLs are utilized by the dynamic delivery module 434. The dynamic delivery module 434 comprises a rules API module 436, a rules engine 438, a device detection module 440 and a playback APIs module 442.

In an example system, the system discussed in connection with FIG. 4 may be integrated into an existing dynamic content item insertion system architecture, for example, a dynamic advertisement insertion (DAI) system architecture. Dynamic content item insertion, such as DAI, may be performed on the client or server side. Utilizing dynamic content item insertion, such as DAI, comprising server-side content item insertion, for example, server-side advertisement insertion (SSAI), may give rise to advantages in terms of overall service quality and superior content item (including, for example, advertisement) engagement. Server-side content item insertion, such as SSAI, tends to improve a viewing experience by facilitating television-style playback of content items, such as, advertisements, inserted on the fly. The content items, such as, advertisements, may be capable of being addressed to one or more individual users, and may be configured to take into account additional factors such as, the season, time of day, weather and/or any surrounding content being consumed. In one example, implementing the logic on the server side may be enable the easier delivery of a homogeneous, professional experience similar to the experience that users were accustomed to under, for example, traditional linear television programming with spot advertisements. Under server-side content item insertion, such as SSAI for example, the video resolution and/or bitrate of the inserted content item or items, such as, advertisements, may be configured to match those of the surrounding (i.e., preceding and/or following) live and/or recorded content. This may give rise to an experience in which there is no discernible change in quality from the video programming to the inserted content item, such as, an advertisement, as there often is with client-side content item, such as, advertisement, insertion.

The devices may request fragments of content from edge servers closer to a point, or points, of consumption that in turn may make it easier to synchronize timing and the overall experience, as well as any two-way interaction. Additional features may be introduced that exploit greater interactivity in a manner that was not previously possible with the return paths of some legacy linear infrastructures. This enables, for example, content personalization, and targeted content items, such as, advertising, which can also integrate content item, such as, an advertisement, editing for personalization as described herein.

Content item personalization described herein can be integrated with all existing content item insertion technology, such as advertisement insertion technology. Examples of existing content item insertion technology include: server-side content item insertion; client-side content item insertion; pre-roll, mid-roll and post-roll content item insertion; interactive and personalized content items; overlay content items; in-stream purchases; in-banner video content items; and/or outstream video content items.

Server-side content item insertion, such as, SSAI, enables content items, such as, advertisements, to be inserted into a stream on the server side, enabling, for example, a seamless consumption experience for a user. Client side content item insertion, such as, client side advertisement insertion (CSAI) enables content items, such as, advertisements, to be inserted into a stream on the client-side, using a user's device to manage the content item, such as, an advertisement, insertion process. Pre-roll, mid-roll and post-roll content item insertion, such as advertisement insertion, enables content items, such as, advertisements, to be placed at the beginning, middle and/or end of streamed content.

Interactive content items, such as, advertisements, enable users to interact with the content item, while personalized content items, such as, advertisements, may be tailored to a user's preferences and/or demographics. Overlay content items, such as, advertisements, appear as an overlay on the streaming content, typically in the form of a banner and/or a semi-transparent box. In-stream purchases are content items, such as, advertisements, that enable a user, or users, to make a purchase directly through the streaming platform. In-banner video content items are content items, such as, advertisements, that are placed within the banner of a, for example, website. Outstream video content items are content items, such as, advertisements, that play outside of main video content, typically in a non-linear format.

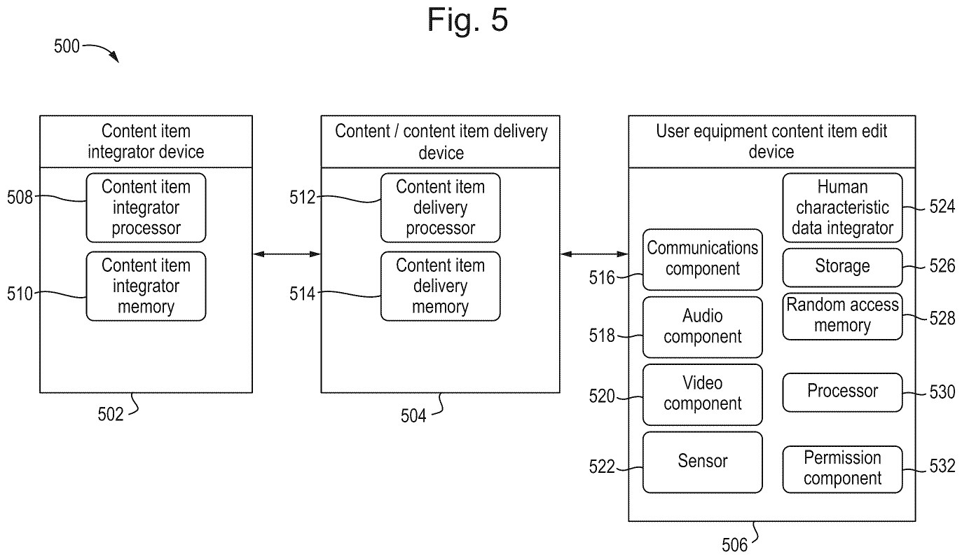

FIG. 5 shows another example environment for altering a content item and delivering the altered content item, in accordance with some embodiments of the disclosure. The environment 500 comprises a content delivery system including one or more example user equipment devices configured to edit content items and/or one or more corresponding modules. The environment 500 comprises a content item integrator device 502, such as an advertisement integrator device, a content and content item delivery device 504, such as an advertisement delivery device, and a User equipment Content item Edit Device (UCED) 506 configured to edit a content item, such as an advertisement.

The content item integrator device 502 may be, for example, a just-in-time packaging content item insertion device, which may be a just-in-time packaging advertisement insertion device. The content item integrator device 502 may comprise a content item integrator processor 508 and a content item integrator memory 510. The content item integrator device may be in communication with the content and content item delivery device 504 via, for example, a network such as the internet. The UCED 506 may comprise a communications component 516, an audio component 518, a video component 520, a sensor 522, a human characteristic data integrator 524, storage 526, RAM 528, a processor 530 and a permissions component 532. The trained models described herein are an example of human characteristic data that can be used to generate images and video. Other types of human characteristic data include models to replicate speech patterns including language, vocabulary and accent, models to replicate movement and pose as well other demographic information (either inferred or known). Generalization to visual elements other than human (such as pets and/or objects) is also covered by the term human characteristics data, even though such pets and/or objects are not human.

Content item personalization, such as, advertisement personalization, may be implemented via the UCED 506. The UCED 506 enables a content item system, such as, an advertisement system, to automatically affect, change and/or edit the presentation of any type of content item directed to a content consumer. To enable a user to edit content item content, the UCED 506 includes storage 526 that stores human characteristic data it may have captured or stored about individuals on its device, or through content consumer interactions on a social media platform. The human characteristic data may include audio, facial image, physical body image, movement data, smell, touch and/or any other type of human characteristic data can be used as an element for altering an element of a content item.

The human characteristic data may be associated with the content consumer, rights owner, contacts of the content consumer and/or other users. For example, the human characteristic data can be used for viewing content items, such as, advertisements, only by the user or by permitted users. The human characteristic data may also be viewed by other users and/or entities whom the user enables with viewing capability and/or viewing rights. The human characteristic data may be generalized and/or de-personalized enough to avoid infringing privacy rights. The UCED 506 may include a human characteristic data rights management component and/or module (not shown).

The UCED 506 may include one or more of a display (not shown), audio component, video component, communications component, sensor, RAM, and a processor (such as a CPU and/or a system on a chip) that controls the components and modules to perform the process described herein. The UCED 506 may include a permissions component that enables a content delivery system to access human characteristic data stored locally or remotely. In a further example, the UCED 506 may be a module and/or an application of a user equipment device, such as a smart television, a smartphone and/or laptop.

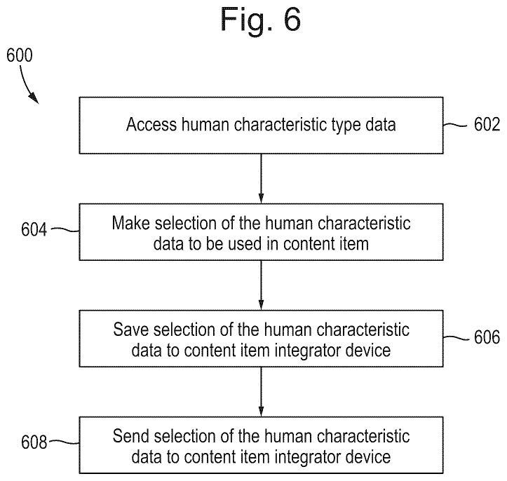

FIG. 6 shows a flowchart of illustrative steps involved in utilizing media items associated with a profile to alter a content item with a trained machine learning model in response to a structured request, in accordance with some embodiments of the disclosure. This example uses human characteristic data as element data; however in embodiments of the invention, human characteristic data can be replaced with other element data types, such as object data or background data, which also includes replacement by the respective media items. Process 600 may be implemented, in whole or in part, on any of the aforementioned computing devices. In addition, one or more actions of the process 600 may be incorporated into or combined with one or more actions of any other processes or embodiments described herein.

At 602, human characteristic type data is accessed, and at 604, a selection of the human characteristic data to be used in a content item, such as, an advertisement, is made. At 606, the section of the human characteristic data is saved to a content item integrator device, such as, an advertisement integrator device, and at 608, the selected human characteristic data is sent to the content item integrator device.

In an example, a UCED 506, such as, a user equipment device comprising a module for editing an advertisement, may utilize the process 600. The UCED 506 may be integrated into a streaming content delivery service, such as a Paramount+, Netflix and/or another streaming service. A content consumer may use the UCED 506 in accordance with a privacy policy of the streaming service. The UCED 506 may enable a content consumer to allow the content consumer's human characteristic data to be stored by the UCED 506 and used in personalized content item generation, such as, for example, personalized advertisement generation ot any other content generation. In a further example, the UCED 506 may initiate prompts to the content consumer to add human characteristic data to their profile. As shown in step 602, the content consumer has enabled access to human characteristic data. The content consumer may add to or delete from the human characteristic storage by connecting to local or remote human characteristic data stored under the content consumer's control. For example, the content consumer may grant access to their smartphone's video and/or photo collections for selection of human characteristic data to store in storage of the UCED 506. The storage of the selected human characteristic data into the streaming service's UCED 506 may be called a human characteristic data profile. In another example, in a social media environment, the content consumer may have already granted permission to access their photos and/or videos collection. A content consumer may also grant permission to the UCED 506 to use their human characteristic data profile to generate personalized content items, such as, advertisements, for other content consumers.

After the UCED 506 has created a human characteristic data profile for the content consumer, the UCED 506 may make a selection of which of the human characteristic data is stored as “permitted human characteristic data” for use in content items, such as, advertisements, as shown in step 604. The content items may be delivered to the content consumer via the content item delivery system, such as, an advertisement delivery system. The UCED 506 may send the permitted human characteristic data for use in editing content item content, such as, advertisement content, that is set to be directed to the content consumer. In an example, the content item system may save the human characteristic data profile and utilize it when distributing streamed content item content, such as, advertising content, to the content consumer, as shown in step 606. In an additional example, based upon the content item delivery system, the human characteristic data may be stored elsewhere, such as the content item content delivery system or the local user equipment.

After the permitted human characteristic data is stored in the human characteristic data profile for use with content item integration, such as, advertisement integration, the particular content item delivery system may use the permitted human characteristic data to edit the content item content, such as, advertisement content, to replace original human characteristic data or template human characteristic data of the original content item with permitted human characteristic data, as shown at 608. This enables a content item comprising a, for example, actor to have the original actor's human characteristic data replaced with the permitted human characteristic data so that the content item would appear to include human characteristics of the contacts with whom the content consumer is familiar. This may enable, for example, viewing of an edited content item to be more entertaining to the content consumer than viewing the original content item content. In another example, the content item delivery system may use the permitted human characteristic data of one or more actors in the content (for example, a streamed program) the content consumer was consuming before being interrupted by a content item break, such as, an advertisement break, to generate a content-related content item, such as, an advertisement, to avoid making the content item unrelated to the content being consumed. The UCED 506 functionality and respective components can also be executed and located remote from the user's content viewing device, by for example a streaming service profile management hardware/software module located within the streaming service user management system.

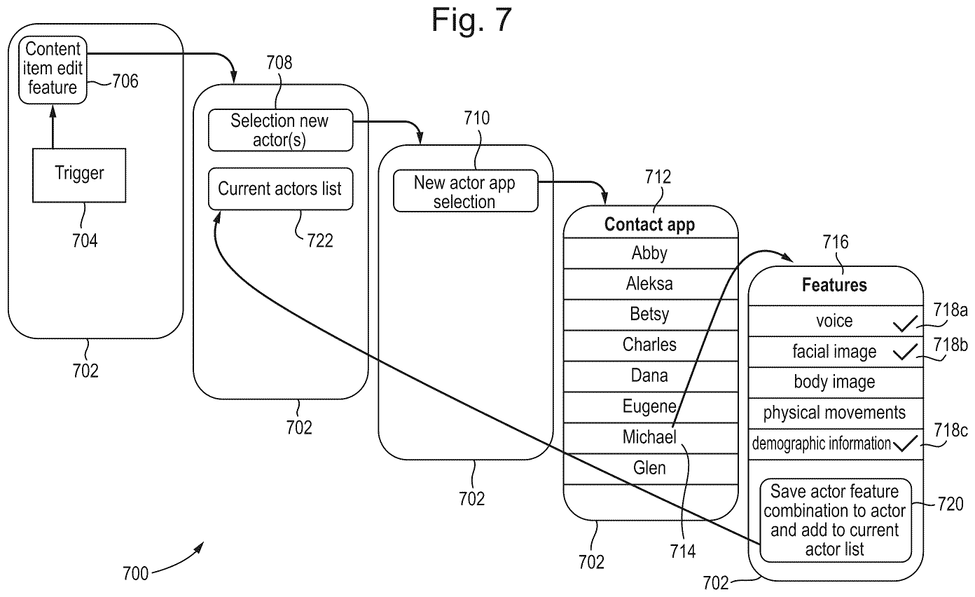

FIG. 7 shows another example environment for utilizing media items associated with a profile to alter a content item with a trained machine learning model in response to a structured request, in accordance with some embodiments of the disclosure. The environment 700 comprises a computing device 702, such as a smartphone. A trigger event 704, such as when a content item, such as, an advertisement, is about to be presented or being prepared to be presented to a content consumer causes a content item edit feature 706 to be initiated at the computing device 702. Another example of a trigger event 704 is receiving the user's content edit selections and/or permissions. If a user has indicated such selections or permissions, then a streaming service system can integrate the selected media item elements, such as selected actor and associated human characteristics data for use in altering future content prior to delivery. The content item edit feature may, for example, be an advertisement edit feature. An example of when a content item is being prepared to be presented to a content consumer is when a manifest file for the content item (such as is the case when the content item is a movie), or associated content item (such as is the case when a movie and has advertisements as the associated content item), is transmitted to the device. For example, the content receiving device receives a manifest file with information, such as segment types and timing to provide for proper reception of the content item. In this example, the manifest file or updated manifest file, such as a rendition file (e.g., in the case of live streaming) can indicate a storage location of the content item to be altered. With the location information of the content item to be altered, the service provider or local client device can alter the content item in accordance with the altering content item selections the user made or has stored in his profile. In an alternative example, a content consumer can send his content item selections or preference list, which contains all selected and allowed human characteristics for association with his profile or account information to a streaming service provider. The service provider can then use the altering content item data to alter all content items that are to be presented to the content consumer while he is using the streaming services of the service provider, or until the user indicates the altering content item feature to stop. By having the information of what the content consumer prefers to see in content items, the service provider can alter the content item more quickly, e.g., before sending the manifest file for the requested streaming service content. In this example, the altering of the content item with the content consumer selections or preferences can be done at the streaming server side.

A content consumer can select to identify a new actor(s) whose human characteristic element(s) can be used to alter content to be viewed by, for example, clicking on a new actor selection button 708. This can lead to selection of particular human characteristic data to be accessed at the computing device 702. The selected actor, or actors, may be for replacing one or more existing actors in a content item. The actor and human characteristic data may be accessed via an existing contact storage and/or any other storage where human characteristic data may be stored. For example, human characteristic data may be accessed from other applications, such as an Apple Photos app and/or Snapchat and/or a game profile or a streaming content profile. In other examples, any element may identified for replacement in the content item, for example a pet, a vehicle and/or a gaming console and associated characteristic data. In other example embodiments, the device 702 functionality and respective components can also be executed and located remote from the user's content viewing device, by for example a streaming service profile management hardware/software module located within the streaming service user management system.

An application associated with the selected actor, or actors, can be selected 710 to access a list of actors at the computing device 702. The selected application 712 is opened at the computing device 702, and a contact 714 is selected. The selected application 712, for example a contact application, may access a contact list comprising a list of people with which the content consumer is familiar with or has favorited or indicated as being desirable for use in altering content in some way, and associated human characteristic data. When a contact is selected, in some examples, based on their relevance for the type of advertisement to be presented to the content consumer, options of available human characteristic data may be accessed for that person. In other example embodiments, the contact may be instead an indicated favorite person, place, or thing, such as a favorite actor in an app 710 embodiment of an IMDB app.

On receiving the selection of a contact, one or more features 716 (based on the accessed human characteristic data) associated with the actor are identified, and one or more of the features are selected at the computing device 702. In this example, the actor's voice 718a, facial image 718b and demographic information 718c are selected. The selected actor feature combination is saved 720 to the actor, and is added to the current actor list. The current actors list 722 may be selected instead of making the selection to add a new actor, or actors 708 to the list.

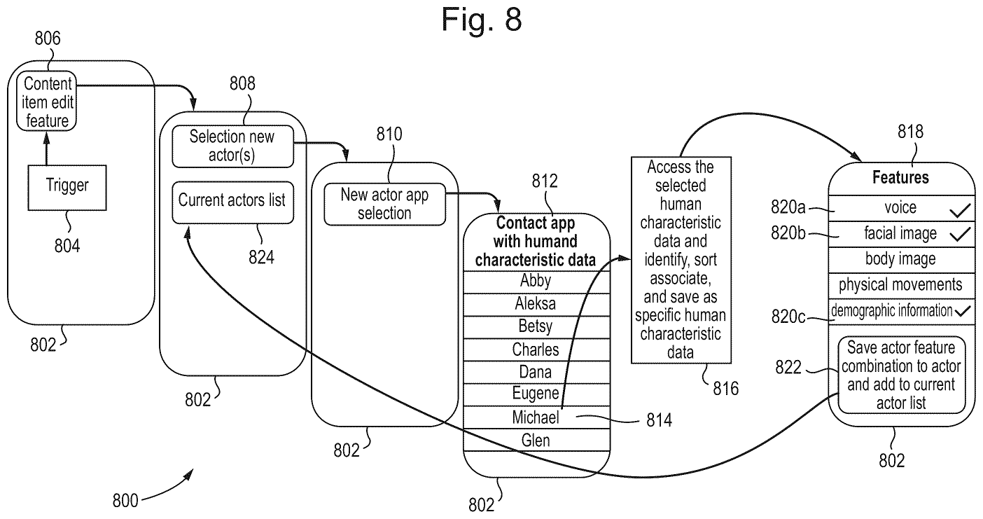

FIG. 8 shows another example environment for utilizing media items associated with a profile to alter a content item with a trained machine learning model in response to a structured request, in accordance with some embodiments of the disclosure. The environment 800 comprises a computing device 802, such as a smartphone. A trigger event 804, such as when a content item, such as, an advertisement, is presented to a content consumer, causes a content item edit feature 806 to be initiated at the computing device 802. Another example of a trigger event 804 is receiving the user's content edit selections and/or permissions. If a user has indicated such selections or permissions, then a streaming service system can integrate the selected media item elements, such as selected actor and associated human characteristics data for use in altering future content prior to delivery. The content item to be edited can be, for example, be an advertisement or any other content. In other example embodiments, the device 802 functionality and respective components can also be executed and located remote from the user's content viewing device, by for example a streaming service profile management hardware/software module located within the streaming service user management system.

One or more new actors are selected 808, and their human characteristic data is accessed at the computing device 802. An application associated with the selected actor, or actors, is selected 810 at the computing device 802. The selected application 812 is opened at the computing device 802, and a contact 814 is selected. The selected application 812 may access a contact list comprising a list of people the content consumer is familiar and associated human characteristic data.

Different from the FIG. 7 embodiment, the FIG. 8 embodiment includes a module 816 that can receive or access the selected human characteristic data to identify, sort, and/or associate, or otherwise further characterize, and save the data as specific human characteristic data. The extra characteristics comparison module 816 can be used to suggest edits of a media element that is similar to a content element. The module 816 can compare content element information with the user selected media element information to generate altered content without specified user input. In another embodiment, the module 816 can enable proper formatting between user selected or permitted media elements with content elements that are to be altered. For example, an alternative human characteristic data storage app can be, for example, a storage app that does not have its stored human characteristic data formatted to interface properly with a UCED 506 processor 530 and integrator 524 as shown in FIG. 5. The UCED 506 processor 530 and integrator 524 may access the selected human characteristic data to perform necessary operations for interoperability via module 816. In one example, the UCED 506 may identify the human characteristic data by categorizing the human characteristic data for proper interoperation.

Proper interoperation categorization includes, for example, identifying, sorting, associating, and saving each human characteristic data of a person in preparation for that human characteristic data to be used in a content item, such as, as a specific actor. After such processing, the UCED 506 device processor 530 may transmit the individual human characteristic data to the UCED 506 as shown in FIG. 8. The UCED device 506 can then access the particular human characteristic data to use the human characteristic data of that person to generate (not shown) a personalized content item, such as, a personalized advertisement having the selected actor human characteristic data in place of the original or stored actor for the content. For example, the next advertisement to be viewed by the content consumer can have a person the selected or for which permission was given, such as a person from user's contact list of a person who recently passed away or a favorite actor or other favorite person, such as a grandchild.

On receiving the selection of a contact, one or more media item elements or features 818 (based on the accessed human characteristic data) associated with the actor are identified, and one or more of the features are selected (not shown) at the computing device 802. In this example, the actor's voice 820a, facial image 820b and demographic information 820c are selected. The selected actor feature combination is saved 822 to the actor, and is added to the current actor list. The current actors list 824 may be selected instead of the selected new actor, or actors of step 808.

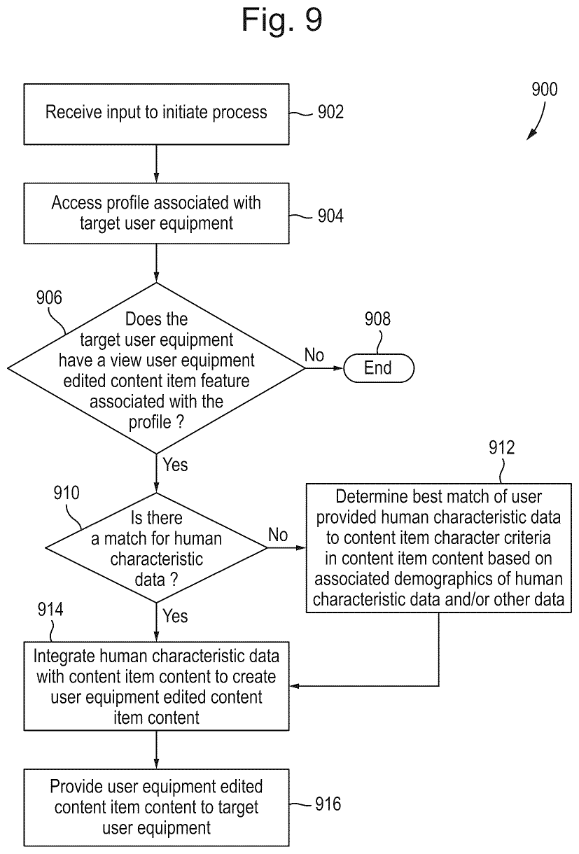

FIG. 9 shows a flowchart of illustrative steps involved in utilizing media item elements associated with a profile to alter a content item with a trained machine learning model in response to a structured request, in accordance with some embodiments of the disclosure. Process 900 may be implemented, in whole or in part, on any of the aforementioned computing devices. In addition, one or more actions of the process 900 may be incorporated into or combined with one or more actions of any other process or embodiments described herein.

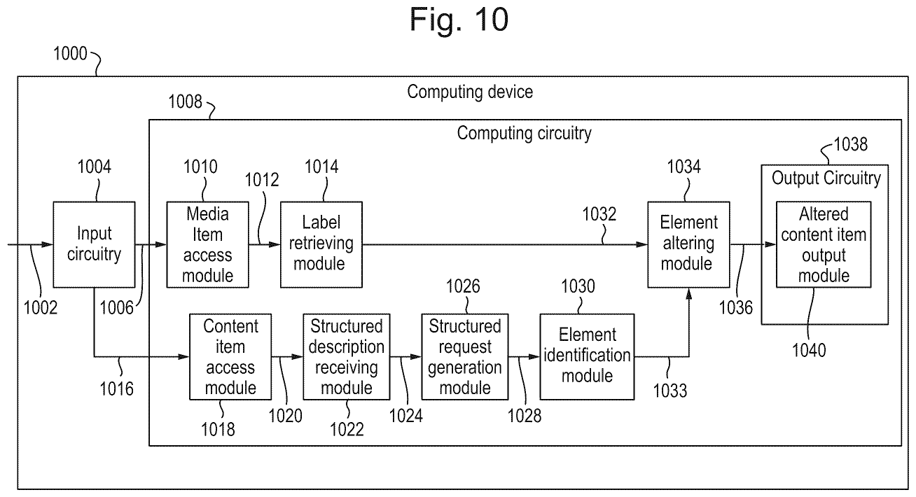

At 902, input or a trigger to initiate the process is received, and at 904, a profile associated with content consumer or target of the altered content user equipment is accessed. At 906, it is determined whether the target user equipment has a feature that allows user equipment to edit a content item associated with the profile, which can be stored locally on the user device or stored remotely from the user in a storage of the user profile or account information associated to the user's subscribed (paid or not paid) streaming service provider. In some examples, the content item may be an advertisement. If it does not, then the process ends at step 908. If the target user equipment has the feature that allows user equipment to edit a content item associated with the profile, then, at 910, it is determined whether there is a match for human characteristic data. If there is not a match, then the process proceeds to step 912, where a best match of user-provided human characteristic data to content item character criteria in the content item content is determined based on associated demographics of human characteristic data and/or other data, as for example, which can be implemented by module 816 having components such computing components of FIG. 10 below. The process then proceeds from step 912 to step 914. If there is a match for human characteristic data, then the process proceeds from step 910 to step 914, where human characteristic data or media element is integrated with content item content to create altered content including the edited content elements, for example altered content of an advertisement including the edited content element of the original advertisement actor with the selected human characteristic data media item elements of the selected favorite actor, e.g., a favorite grandchild or favorite pet or favorite cartoon character. The process proceeds to step 916, where edited content item content is provided to target user equipment.

Process 900 shows an example of a process for editing a content item with user equipment, such as, an advertisement edit process. The process 900 may be implemented on a user equipment content item edit device, such as UCED 506 in the content delivery system shown in FIG. 5 to control the content item, such as, an advertisement, delivery process to produce the customized target content item result. In an example, the UCED 506 may determine whether a user of a streaming service has an associated UCED 506 feature, as shown at step 906. If it does, then the streaming service's associated content item integrator device 502 may determine, at 910, whether the received and/or stored selected human characteristic data can be used with the content item content destined to be transmitted to the content consumer. For example, the content item integrator device 502 may determine whether one or more actors in the content item content can be edited to use the human characteristic data of the targeted content consumer, or other content consumers, in the content consumer's social circle. For example, content item integrator device 502 may compare the demographics of the identified actor in the content item content with the demographics of the human characteristic data. For example, if the demographic of the actor in the original, or template, content item content is one of an adult in the age range of 20-40 years old, who interacts with a child actor in the age range of 4-7 years old, then human characteristic data of a person with age demographics of 65-110 years old would not be utilized for that actor part. If, for example, this was the only person for whom human characteristic data is associated with the content consumer, then the content item may remain as the original with no edits and/or alterations.

In another example, the content item integrator device 502 may match the best-fitting available human characteristic data with the demographic of one or more of the actors in the content item, as shown at 912, so that even when there is no match, the content item can still be altered based on the available human characteristic data, which may still result in a more entertaining or relatable content item. In another example, the content consumer may override all content item integrator device 502 matching to always select human characteristic data that is, for example, stored as a favorite. For example, a content item system may have determined that a content consumer may want every content item to play with the main actor's human characteristic data to be edited to be the human characteristic data of the content consumer's best friend.

In a further example, the advertising content may be filled with an animal actor, such as a dog or a cat. In this example, animal characteristic data of the animal actor may be edited to be replaced with the animal characteristic data stored in the UCED 506 similarly to how the human content data is stored and processed.

When the content item integrator device 502 determines that, for example, an actor in the content item may be edited with the human characteristic data, then the content item integrator device 502 may create edited content item content by editing content items for a targeted content consumer, as shown at 914. The content item integrator device 502 may also store the human characteristic data associated with the content consumer in a profile that the content consumer has associated with a streaming service profile associated with the content consumer. In another example, a streaming service may control and maintain the content item edit functionality described herein by having one of its devices function as the described content item integrator device 502. In this way, the streaming service may communicate with a content item content provider to receive original content item content and then edit the content item before streaming it along with entertainment content that the content consumer selected to view. In an example, the human characteristic data associated with the content consumer may be stored with the content consumer's profile at the streaming service system.

In some examples, content consumers may directly select what other content consumers, animals and/or items they want to be used in a personalized content item that they receive via a dedicated user interface that replicates the UCED device processes described above.

In another example, the user is prompted to indicate whether they would like to adjust the content item for increased viewing pleasure. If an input associated with a confirmatory user interface element is received, then the user may be prompted through the process. For example, before the content item starts, the user may be prompted as to whether they would like to edit the content item. If an input associated with a confirmatory user interface element is received, the user may be prompted with options. In some examples, a user interface input may be utilized to select the level of alternation. For example, a user may enable content items to be shown on their friend's feed with their likeness, but only with a likeness of 75% (i.e., it looks like the user, but it is not the user).

FIG. 10 shows a block diagram representing components of a computing device and dataflow therebetween for utilizing media items associated with a profile to alter a content item with a trained machine learning model in response to a structured request, in accordance with some embodiments of the disclosure. Computing device 1000 comprises input circuitry 1004, control circuitry 1008 and output circuitry 1038. The computing device 1000 may be, for example, a remote cloud computer. In other examples, the computing device may be, for example, a local computing device, such as a smartphone. Control circuitry 1008 may be based on any processing circuitry (not shown) and comprises control circuits and memory circuits, which may be disposed on a single integrated circuit or may be discrete components and processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any number of cores). In some embodiments, processing circuitry may be distributed across multiple separate processors or processing units, for example, multiple of the same type of processing units (e.g., two Intel Core i9 processors) or multiple different processors (e.g., an Intel Core i5 processor and an Intel Core i7 processor) and/or a system on a chip (e.g., a Qualcomm Snapdragon 888). Some control circuits may be implemented in hardware, firmware, or software.

Input is received 1002 by the input circuitry 1004. The input circuitry 1004 is configured to receive inputs related to a computing device. For example, this may be via a touchscreen, a Bluetooth and/or Wi-Fi controller of the computing device 1000, an infrared controller, a keyboard, a mouse and/or a microphone. In another example, this may be via a gesture detected via an extended reality device. In a further example, the input may comprise instructions received via another computing device. The input circuitry 1004 transmits 1006 the user input to the control circuitry 1008.

The control circuitry 1008 comprises a media item access module 1010, a label retrieving module 1014, a content item access module 1018, a structured description receiving module 1022, a structured request generation module 1026, an element identification module 1030, an element altering module 1034, and output circuitry 1038 comprising an altered content item output module 1040. The input is transmitted 1006 to the media item access module 1010, where one or more media items associated with a user profile are accessed. The one or more media items are transmitted 1012 to the label retrieving module 1014, where, for each media item, one or more labels associated with one or more elements in the media item are retrieved.

The input circuitry 1004 also transmits 1016 an input to the content item access module 1018, where a content item is accessed. The accessed content item is transmitted 1020 to the structured description receiving module 1022, where a structured description of one or more elements in the content item is received. The structured description and content item are transmitted 1024 to the structured request generation module 1026, where a structured request to alter one or more elements in the content item is generated based on the structured description. The content item and the structured request are transmitted 1028 to the element identification module 1030, where one or more elements to alter are identified in the content item.

The one or more accessed media items and the retrieved labels are transmitted 1032 from the label retrieving module 1014 to the element altering module 1034, and the accessed content item, the structured request, and an indication of the identified elements are also transmitted 1033 to the element altering module 1034. The one or more elements in the content item are altered at the element altering module 1034 to generate an altered content item, where the altering is based on the one or more labels, the one or more associated media items and the structured request. The altered content item is transmitted 1036 from the element altering module 1034 to the output circuitry 1038 where the altered content item is generated for output by the altered content item output module 1040.

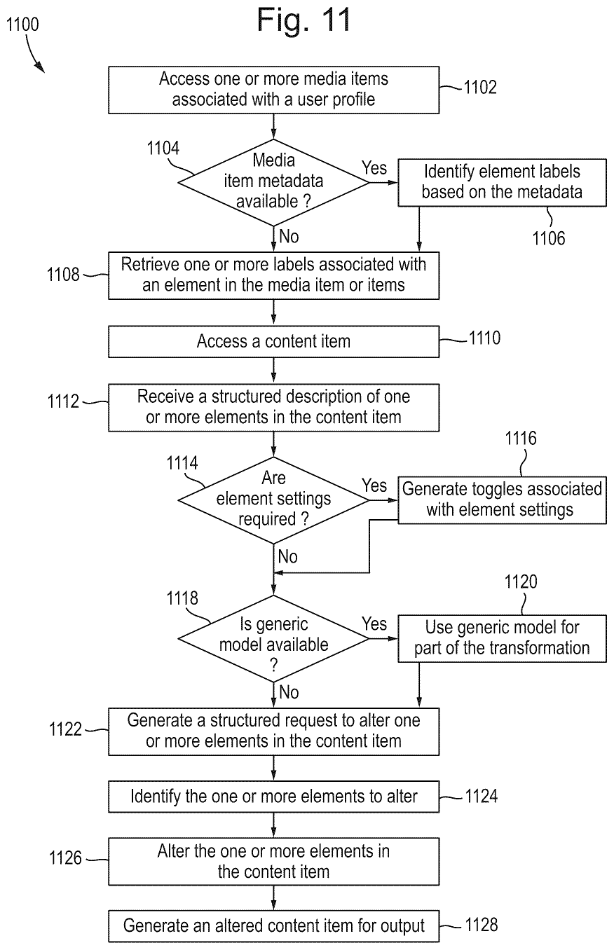

FIG. 11 shows a flowchart of illustrative steps involved in utilizing media item elements associated with a profile to alter a content item element with a trained machine learning model in response to a structured request, in accordance with some embodiments of the disclosure. Process 1100 may be implemented, in whole or in part, on any of the aforementioned computing devices. In addition, one or more actions of the process 1100 may be incorporated into or combined with one or more actions of any other process or embodiments described herein.

At 1102, one or more media item elements associated with a user profile are accessed, and, at 1104, it is determined whether content item metadata is available that indicates which element of a content item can be altered with a user's selected or permitted media item element. If content item metadata is available, then element labels are identified based on the available metadata at 1106, and the process proceeds to step 1108. If, at 1104, content item metadata is not available, then the process proceeds to step 1108. At step 1108, one or more labels associated with an element in the media item element or item elements are retrieved. At 1110, a content item is accessed, and, at 1112, a structured description of one or more elements in the content item is received. At 1114, it is determined whether element settings are required for one or more of the one or more elements. If element settings are required, then, at 1116, a user interface comprising toggles associated with settings for one or more of the one or more media item elements is generated, and the process proceeds to step 1118. If, at 1114, it is determined that element settings are not required, the process proceeds to step 1118. A structured description is a text description of what the content item and its elements are. The text description can be used to match or identify content item elements that can be altered or edited with the selected media item elements.

At 1118, it is determined whether a generic model is available. If a generic model is available, then the process proceeds to step 1120, where a generic model is used for part of the alteration, and the process proceeds to step 1122. If a generic model is not available at 1118, then the process proceeds to step 1122, where a structured request to alter one or more elements in the content item is generated. At step 1124, the one or more elements to alter are identified, and, at step 1126, the one or more elements in the content item are altered. At step 1128, an altered content item is generated for output.

In some examples, a streaming service may take a selected media item or item element(s) that is to be used to altered a content item or to alter content item element(s), and this item or element can be decoded into a universal latent state via a deep learning model. This encoding may make use of a universal encoder that only encodes the minimum data in order to more speedily create the universal latent state. The universal latent state may be decoded via a generic decoder that can decode for a general population of elements. An efficiency advantage arises with respect to traditional deep learning and general adversarial network approaches, as the approach does not require such intensive processing resources due to the use of a generic decoder, rather than specific encoders decoder pairs for each different element within a group of elements, such as for each face in a group of faces. Such generic encoder decoder pairs may be utilized in situations where a user does not need to be presented with a realistic alternation of a content item, such as, where a user is inserted into an advertisement. Such a generic encoder and decoder may be stored at, for example, a client device, a streaming server(s) and/or third party content item servers, such as, advertisement servers. In an example, a face in the content item to be altered may be encoded to produce a universal latent face, by using a universal encoder that only encodes the minimum face data to create the universal latent face. The generic decoder may be a generic decoder that can decode for a general population of faces.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be illustrative and not limiting. Furthermore, it should be noted that the features and limitations described in any one embodiment may be applied to any other embodiment herein, and flowcharts or examples relating to one embodiment may be combined with any other embodiment, done in different orders, or done in parallel. In addition, the systems and methods described herein may be performed in real time. It should also be noted that the systems and/or methods described above may be applied to, or used in accordance with, other systems and/or methods.

1. A method comprising:
accessing, at a computing device, one or more media items associated with a user profile;
retrieving, for each media item, one or more labels associated with an element in the media item;
accessing a content item;
receiving a structured description of one or more elements in the content item;
generating, based on the structured description, a structured request to alter one or more elements in the content item;
identifying, in the content item and based on the structured request, the one or more elements to alter;
altering the one or more elements in the content item, the altering performed using a trained machine learning model and based on the one or more labels, the one or more media items, and the structured request; and
generating, for output, an altered content item comprising the one or more altered content item elements.

2. The method of claim 1, wherein the one or more labels for each media item are retrieved based on metadata associated with the one or more media items.

3. The method of claim 1, further comprising identifying a relationship between the user profile and each of the one or more media items by comparing a respective retrieved label with data associated with the user profile.

4. The method of claim 1, wherein the same label is applied to a subset of the one or more media items.

5. The method of claim 1, wherein the media item comprises an image of a person, pet, or object related to the user profile.

6. The method of claim 1, wherein the structured request to alter an element in the content item comprises using a generic model to perform at least a part of the altering

7. The method of claim 1, further comprising:
generating, based on the user profile, one or more toggles, each toggle associated with selecting a setting for an element of the one or more elements;
receiving input, via the one or more toggles, to select one or more settings, each setting associated with one or more elements; and
wherein the altering the one or more elements in the content item further includes applying the selected one or more settings to the associated one or more elements.

8. The method of claim 1, wherein the structured request to alter the one or more elements in the content item further comprises an instruction to alter one of the elements in the content item with an element from a subset of the one or more media items.

9. The method of claim 8, wherein the structured request to alter the one or more elements in the content item further comprises an instruction to change a size of one or more of the altered content item elements in the content item.

10. The method of claim 8, wherein the structured request to alter the one or more elements in the content item further comprises an instruction to change a location of one or more of the altered content item elements in the content item.

11. The method of claim 8, wherein the structured request to alter the one or more elements in the content item further comprises an instruction to alter a background element in the content item.

12. The method of claim 1, wherein the content item is a personalized advertisement, movie trailer, movie, other video.

13. A system comprising:
input/output circuitry configured to:
receive an input at a first device;
processing circuitry configured to:
access, at a computing device, one or more media items associated with a user profile;
retrieve for each media item, one or more labels associated with an element in the media item;
access a content item;
receive a structured description of one or more elements in the content item;
generate, based on the structured description, a structured request to alter one or more elements in the content item;
identify, in the content item and based on the structured request, the one or more elements to alter;
alter the one or more elements in the content item, the altering performed using a trained machine learning model and based on the one or more labels, the one or more media items, and the structured request; and
generate, for output, an altered content item comprising the one or more altered content item elements.

14. The system of claim 13, wherein the processing circuitry configured to retrieve one or more labels for each media item is further configured to retrieve the one or more labels for each media item based on metadata associated with the one or more media items.

15. The system of claim 13, wherein the processing circuitry is further configured to identify a relationship between the user profile and each of the one or more media items by comparing a respective retrieved label with data associated with the user profile.

16. The system of claim 13, wherein the same label is applied to a subset of the one or more media items.

17. The system of claim 13, wherein the media item comprises an image of a person, pet, or object related to the user profile.

18. The system of claim 13, wherein the structured request to alter an element in the content item comprises using a generic model to perform at least a part of the altering.

19. The system of claim 13, further comprising processing circuitry configured to:
generate, based on the user profile, one or more toggles, each toggle associated with selecting a setting for an element of the one or more of elements;
receive input, via the one or more toggles, to select one or more settings, each setting associated with one or more elements; and
wherein the processing circuitry configured to alter the one or more elements in the content item further includes processing circuitry configured to apply the selected one or more settings to the associated one or more elements.

20. The system of claim 13, wherein the structured request to alter the one or more elements in the content item further comprises an instruction to alter one of the elements in the content item with an element from a subset of the one or more media items.

21-60. (canceled)
